(19) United States
(12) Patent Application Publication
(10) Pub. No.: US 2010/0308682 A1
(43) Pub. Date: Dec. 9, 2010

(54) Stator Manufacturing Method for a Motor and Stator Utilizing the same

(75) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: Sunonwealth Electric Machine Industry Co., Ltd., Kaohsiung (TW)

(21) Appl. No.: 12/758,076

(22) Filed: Apr. 12, 2010

(30) Foreign Application Priority Data
Jun. 9, 2009 (TW) 098119200

(51) Int. Cl. H02K 15/02; H02K 1/06

(52) U.S. Cl. 310/195; 29/596

(57) ABSTRACT

A stator manufacturing method for a motor comprises a preliminary step configured to provide a strip plate having at least one wound portion on a surface thereof; a winding step configured to provide a coil unit and wind the coil unit around the at least one wound portion of the strip plate; a rolling step configured to roll up the strip plate into an unshaped sleeve having a central hole, wherein the at least one wound portion and the coil unit are located inside the central hole; and a shaping step configured to shape the unshaped sleeve into a shaped sleeve.

### BACKGROUND OF THE INVENTION

1. Field of the Invention

The present invention generally relates to a stator manufacturing method for a motor and a stator utilizing the method and, more particularly, to a simplified stator manufacturing method for a motor and a stator utilizing the simplified method.

2. Description of the Related Art

The modern available stators are mainly categorized as two categories: the stators for inner-rotor-type motors and the stators for outer-rotor-type motors. Generally, the stators for both types of motors have substantially the same manufacturing procedures. Take the inner-rotor-type motors as an example, the stator structure and manufacturing method thereof will be illustrated.

Please refer to FIG. 1, a stator manufacturing method for a stator 80 of a conventional motor comprises the following procedures. Firstly, a plurality of silicon steel plates 81 is formed by a punching process; and each of the silicon steel plates 81 is stacked with each other to form a silicon steel entity. Secondly, an upper bobbin 82 is coupled to an end of the silicon steel entity and a lower bobbin 83 is coupled to another end of the silicon steel entity. Finally, a coil unit 84 comprising a plurality of coils 841 is wound around the silicon steel entity as well as predetermined portions of the upper bobbin 82 and the lower bobbin 83, thus forming the stator 80.

In general, the stator manufacturing method of the stator 80 has some drawbacks illustrated below.

1. The stator 80 requires complex manufacturing procedures. As described above, manufacturing inconvenience is caused as each silicon steel plate 81 has to be individually formed by the punching process. Moreover, during the assembly, the silicon steel plates 81 have to be stacked up to form the silicon steel entity so that the upper bobbin 82 and the lower bobbin 83 are allowed to couple to two ends of the silicon steel entity. Afterwards, the coil unit 84 is allowed to wind around the silicon steel entity, the upper bobbin 82 and the lower bobbin 83. The procedures above are very complex and have some problems such as high cost and assembly difficulty.

2. The stator 80 as a finished product has lower quality. During the manufacturing process of the stator 80, the winding of the coil unit 84 has to be performed after the silicon steel plates 81, the upper bobbin 82 and lower bobbin 83 are assembled. This results in a space limit for the winding of the coil unit 84. Due to the space limit, the distance between each two adjacent coils 841 can not be shortened so that the number of turns of the coil unit 84 and the diameter of wire of the coil unit 84 can not be increased. As a result, when the stator 80 is used in a motor, the torque and rotational speed of the motor can not be efficiently increased.

3. The winding of coil unit 84 is difficult. As shown in FIG. 1, the silicon steel plates 81 are substantially in a circular form. Based on the structure, it would be difficult to wind the coil unit 84 around the silicon steel entity along an inner peripheral surface thereof. Therefore, the cost of assembly is increased and the assembly time is prolonged. Furthermore, the stator 80 might have poorer quality if the coil unit 84 is accidentally scratched (or damaged) during the assembly.

Since the silicon steel plates 81, upper bobbin 82, lower bobbin 83 and coil unit 84 are used to form the stator 80, some potential problems are raised, as elaborated below.

1. The axial height of a motor using the stator 80 is not easy to be reduced. Due to the difficulty in reducing the axial height, the conventional stator 80 no longer fits to the need of current design requirement as the modern available motors have a tendency towards a miniature design. The difficulty in reducing the axial height is resulted from the complex components of the stator 80, such as the stacked silicon steel plates 81, upper bobbin 82 and lower bobbin 83 and so on. In such a case where the stator 80 is used in a motor, the axial height of the motor cannot be efficiently reduced, leading to a difficulty in implementing a miniaturized motor.

2. The motor using the stator 80 does not have a stable operation. In an application where the stator 80 is used in a motor to drive a rotor thereof, a torque variation or an uneven torque is likely to occur when the rotor having a permanent magnet with a plurality of interlaced N/S poles rotates relatively to the silicon steel plates 81. This is called a cogging torque. This often occurs in a case where the rotor rotates in a lower speed.

Please refer to FIG. 2; Taiwan utility patent M248128 discloses a stator 90 of a conventional motor. The stator 90 comprises a plurality of magnetic conducting members 91, each comprising a rib 911 and an arm 912. The rib 911 is wound with a coil 92. The arm 912 comprises two coupling portions 913 on two ends thereof. Through the coupling portions 913, the conducting members 91 may be combined together to form a stator.

In the manufacture of the stator, the conducting members 91 are formed via powder metallurgy. Following, the coil 92 is wound around the rib 911 of each magnetic conducting member 91. At the final stage, the magnetic conducting members 91 are coupled together as an entity via the coupling portions 913.

Generally speaking, the winding of the coil 92 for the stator 90 is performed prior to the coupling of the magnetic conducting members 91. Therefore, better winding flexibility is provided. However, although the stator 90 has a flexible winding for the coil 92, the stator 90 still has drawbacks such as inconvenient assembly as each magnetic conducting member 91 requires to be assembled one by one, causing an inconvenient assembly. In addition, the manufacture of the stator 90 still requires components such as magnetic conducting members 91. As a result, drawbacks of the aforementioned stator 80, such as high cost, difficulty in reducing axial height, unstable operation and so on, are still presented when using the stator 90.

### SUMMARY OF THE INVENTION

It is therefore the primary objective of this invention to overcome the above drawbacks by providing a simplified manufacturing method for a stator of a motor.

It is another objective of the invention to provide a manufacturing method for a stator of a motor which produces a motor with better quality.

It is yet another objective of the invention to provide a manufacturing method for a stator of a motor which simplifies the winding of the stator.

It is yet another objective of the invention to provide a stator of a motor manufactured based on the above methods, thereby efficiently reducing the axial height thereof.

It is yet another objective of the invention to provide a stator of a motor which operates with less cogging torque.

The invention discloses a stator manufacturing method for a motor, comprises a preliminary step configured to provide a strip plate having at least one wound portion on a surface thereof; a winding step configured to provide a coil unit and wind the coil unit around the at least one wound portion of the strip plate; a rolling step configured to roll up the strip plate into an unshaped sleeve having a central hole, wherein the at least one wound portion and the coil unit are located inside the central hole; and a shaping step configured to shape the unshaped sleeve into a shaped sleeve.

Furthermore, the invention discloses a stator manufacturing method for a motor, comprising a preliminary step configured to provide a strip plate having at least one wound portion on a surface thereof; a winding step configured to provide a coil unit and wind the coil unit around the at least one wound portion of the strip plate; a rolling step configured to roll up the strip plate into an unshaped sleeve having a central hole, wherein the at least one wound portion and the coil unit are located outside the central hole; and a shaping step configured to couple two ends of the strip plate so as to shape the unshaped sleeve into a shaped sleeve.

The stator manufacturing methods above only require rolling up a strip plate into an unshaped sleeve and shaping the unshaped sleeve into a shaped sleeve after a coil unit is wound around at least one wound portion of the strip plate. Thus, advantages such as simplified manufacturing and easy winding are provided.

Furthermore, the invention discloses a stator of a motor, comprising an unshaped sleeve in form of a rolled-up strip plate and having a plurality of wound portions wound with a coil unit.

The stator above may omit the conventional silicon steel plates required for manufacturing a conventional stator. Therefore, advantages such as lower cost and reduced axial height, easy assembly and stable operation and so on are provided.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a manufacturing process of a conventional stator of a motor.

FIG. 2 shows a structure of a conventional stator of a motor.

FIG. 3 shows a manufacturing flowchart of a stator of a motor according to a first embodiment of the invention.

FIG. 4a shows a manufacturing process of the stator of the motor during step S11 according to the first embodiment of the invention.

FIG. 4b shows a manufacturing process of the stator of the motor during step S12 according to the first embodiment of the invention.

FIG. 4c shows a manufacturing process of the stator of the motor during step S13 according to the first embodiment of the invention.

FIG. 4d shows a first manufacturing method of the stator of the motor during step S14 according to the first embodiment of the invention.

FIG. 4e shows a second manufacturing method of the stator of the motor during step S14 according to the first embodiment of the invention.

FIG. 5 shows a manufacturing flowchart of a stator of a motor according to a second embodiment of the invention.

FIG. 6a shows a manufacturing process of the stator of the motor during step S21 according to the second embodiment of the invention.

FIG. 6b shows a manufacturing process of the stator of the motor during step S22 according to the second embodiment of the invention.

FIG. 6c shows a manufacturing process of the stator of the motor during step S23 according to the second embodiment of the invention.

FIG. 6d shows a manufacturing method of the stator of the motor during step S24 according to the second embodiment of the invention.

FIG. 7 shows a first assembly diagram of a strip plate according to a stator manufacturing method of the invention.

FIG. 8 shows a second assembly diagram of a strip plate according to the stator manufacturing method of the invention.

FIG. 9 shows a diagram of a plurality of wound portions embedded with magnetic conducting elements during a preliminary step according to a stator manufacturing method of the invention.

FIG. 10 shows another diagram of a plurality of wound portions embedded with magnetic conducting elements during a preliminary step according to a stator manufacturing method of the invention.

FIG. 11 shows a structure of a stator capable of preventing undesired rolling of a sleeve of the stator according to a stator manufacturing method of the invention.

FIG. 12 shows a diagram of shaping the sleeve during a shaping step according to a stator manufacturing method of the invention.

FIG. 13 shows an assembly diagram of a coil unit during preliminary and winding steps according to a stator manufacturing method of the invention.

FIG. 14 shows a sleeve having a coil unit and an outer coil unit located side by side on two surfaces thereof according to a stator manufacturing method of the invention.

FIG. 15 shows a sleeve having a coil unit located in an interlaced manner with an outer coil unit according to a stator manufacturing method of the invention.

FIG. 16 shows a 3-dimensional diagram of the stator according to a first embodiment of the invention.

FIG. 17 shows a 3-dimensional diagram of the stator according to a second embodiment of the invention.

FIG. 18 shows a 3-dimensional diagram of the stator according to a third embodiment of the invention.

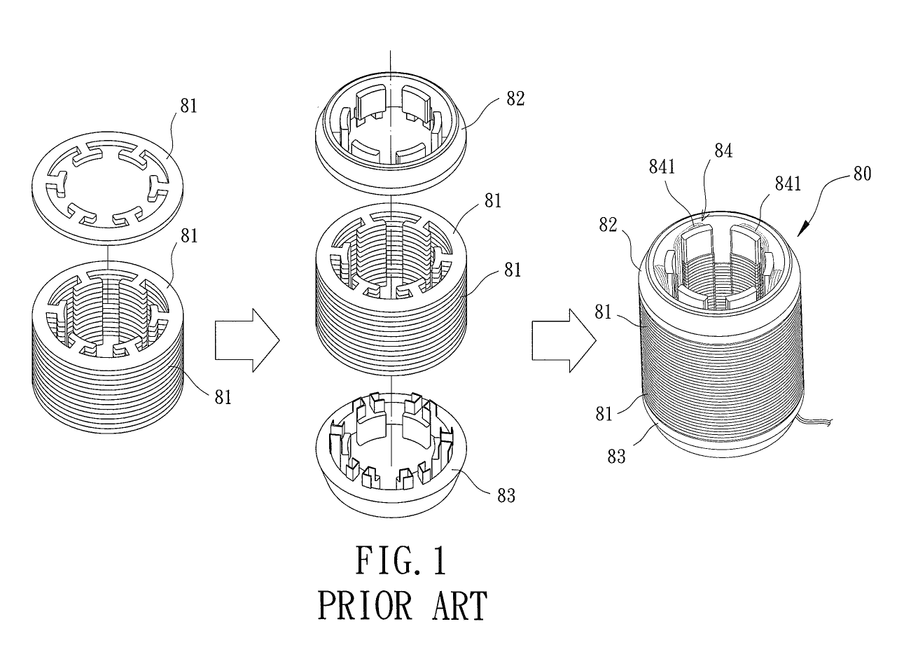

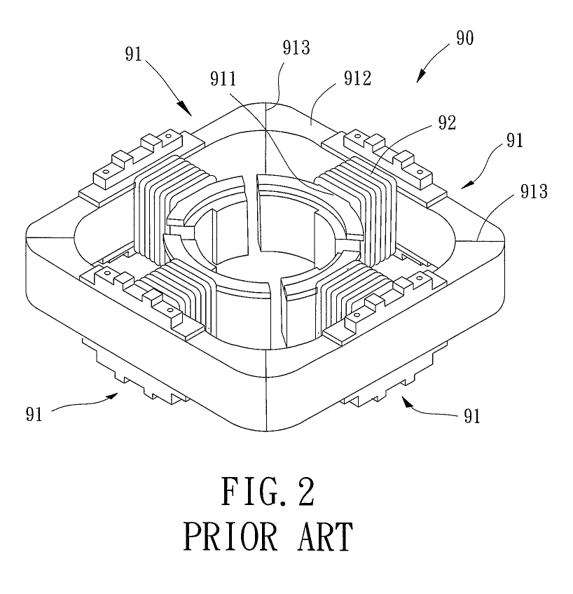

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

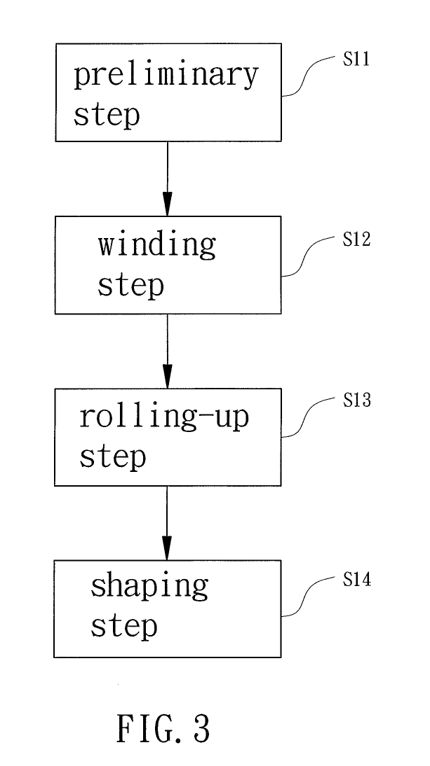

Referring to FIG. 3, a manufacturing method for a stator of an inner-rotor-type motor is disclosed according to a first embodiment of the invention. The method comprises at least a preliminary step S11, a winding step S12, a rolling step S13 and a shaping step S14.

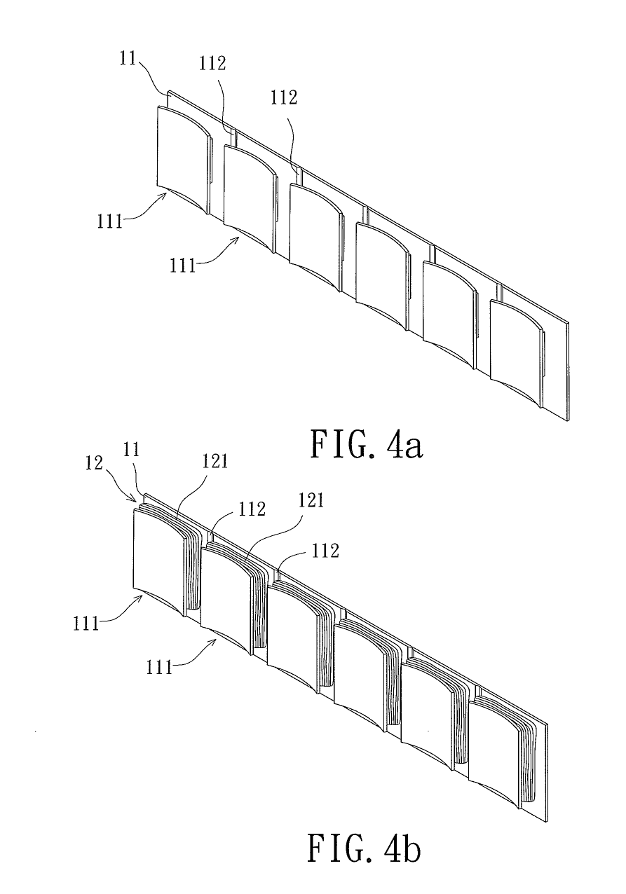

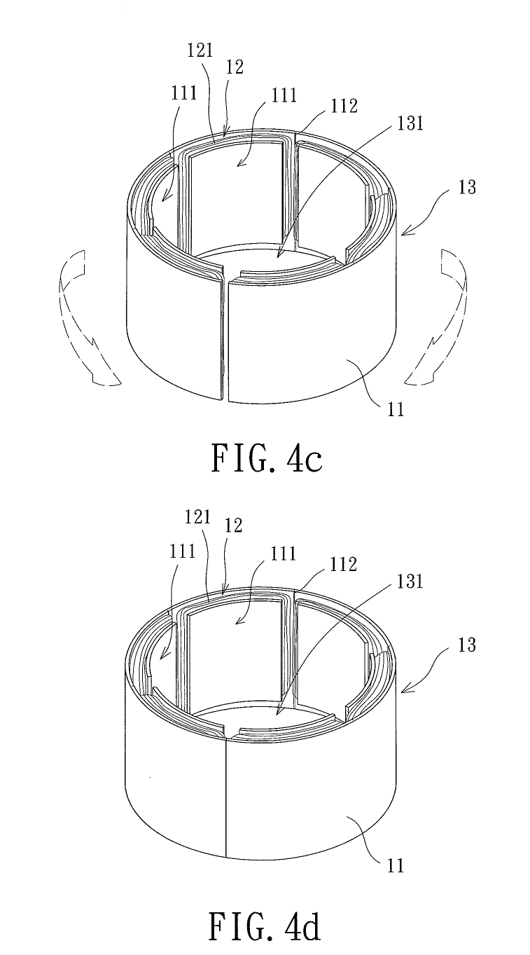

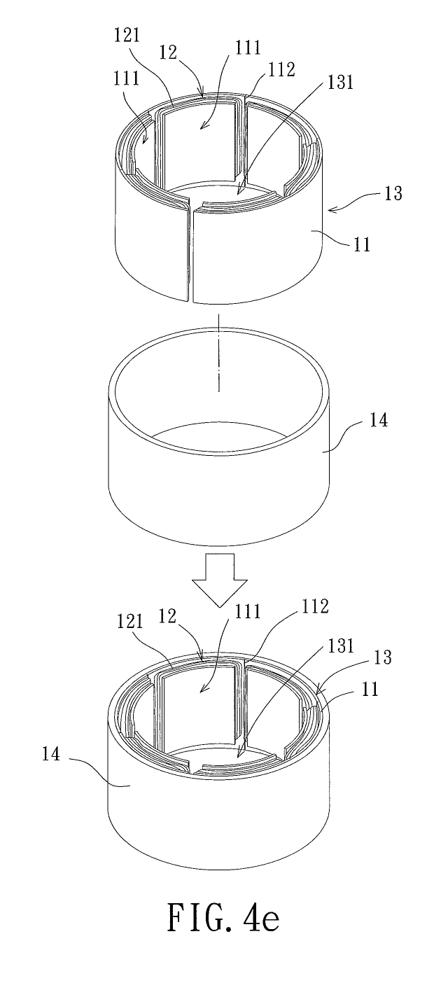

Referring to FIG. 4a, the preliminary step S11 is to provide a strip plate 11 preferably made of an insulation material in order to reduce the cogging torque. At least one wound portion 111 is formed on a surface of the strip plate 11. The at least one wound portion 111 may be integrally formed on the surface of the strip plate 11. Alternatively, the at least one wound portion 111 may also be independently manufactured in advance and then mounted on the surface of the strip plate 11 thereafter. Preferably, the strip plate 11 may be processed to form at least one groove 112 on the surface thereof, with the at least one wound portion 111 and the at least one groove 112 locating on the same surface for the subsequent rolling step S13. As shown in FIG. 4a, a plurality of wound portions 111 is integrally formed on a surface of the strip plate 11 and the strip plate 11 is processed to form a plurality grooves 112, with each groove 112 located between two adjacent wound portions 111.

Also with reference to FIG. 4b, the winding step S12 is to provide a coil unit 12 comprising a plurality of coils 121, each being wound around an individual wound portion 111. As shown in FIG. 4b, the invention provides a great convenience for the winding of the coil unit 12 as the winding of the coil unit 12 is performed in an open space on a side of the strip plate 11.

Referring to FIG. 4c, the rolling step S13 is to roll up the strip plate 11 by a machine or manpower so as to form an unshaped sleeve 13 having a central hole 131, with the wound portions 111 and the coil unit 12 located within the central hole 131. Furthermore, the grooves 112 formed on the surface of the strip plate 11 may facilitate rolling-up of the strip plate 11.

The shaping step S14 is to fix the shape of the unshaped sleeve 13 into a cylinder so as to form a stator structure. There are several ways of shaping the unshaped sleeve 13 as described below.

In FIG. 4d, two ends of the strip plate 11 are coupled together to shape the unshaped sleeve 13 into a shaped sleeve. The two ends of the strip plate 11 may be coupled together by ways of buckling, adhesion, soldering and so on. Alternatively, as shown in FIG. 4e, an outer sleeve 14 is used to receive the unshaped sleeve 13 for fixing the unshaped sleeve 13 into a fixed cylindrical form. The outer sleeve 14 is preferably made of a material capable of preventing magnetic fields leakage. Alternatively, the unshaped sleeve 13 may be disposed in the outer sleeve 14 after the two ends of the strip plate 11 are coupled together. In this way, the unshaped sleeve 13 may be shaped better.

With the above manufacturing steps, the proposed manufacturing method of a stator of a motor may achieve at least the following advantages according to the first embodiment of the invention.

1. The invention achieves simple manufacture of a stator of a motor. The invention provides a way to manufacture a stator of a motor by simply rolling up the strip plate 11 into an unshaped sleeve 13 and shaping the unshaped sleeve 13 into a shaped sleeve after the wound portions 111 are wound with the coil unit 12. Based on this, the invention simplifies the manufacturing steps for a stator of a motor while reducing the cost and improving the assembly convenience.

2. The invention achieves easy winding. Since the winding of the coil unit 12 is performed before the strip plate 11 is rolled up into the unshaped sleeve 13, the invention achieves a great winding convenience for the coil unit 12 as the winding has been done in an open space on a side of the strip plate 11. In this way, manpower required for assembly is reduced and assembly time is shortened. Furthermore, the potential scratches or damages of the coil unit 12 caused during the assembly may be avoided, thereby improving the quality of the motor.

In addition, during the manufacture of the stator, the number of the turns of each coil 121 may be appropriately increased and the diameter of the wire may also be increased due to the winding convenience. More importantly, because the coil unit 12 is disposed inside the central hole 131, each coil 121 may stay more close to each other after the winding of the coil unit 12 is finished and the strip plate 11 is rolled up into the unshaped sleeve 13. In this way, the manufactured stator, when applying to a conventional motor, may efficiently increases the torque and rotational speed of the motor, thus providing stable operation.

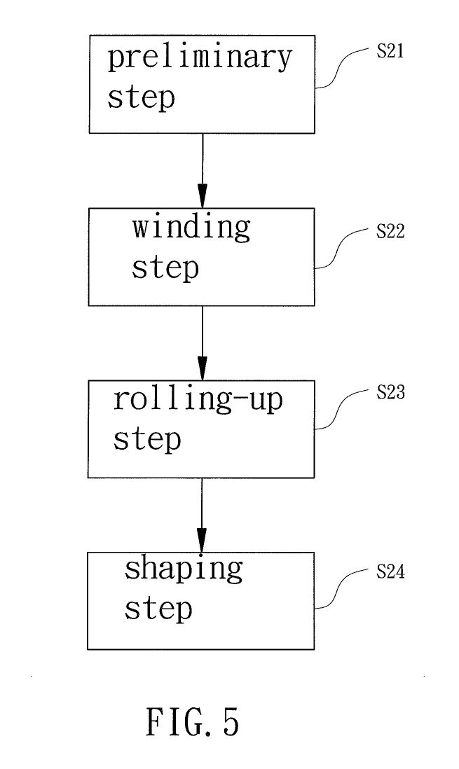

Referring to FIG. 5, a manufacturing method for a stator of an outer-rotor-type motor is disclosed according to a second embodiment of the invention. The method comprises at least a preliminary step S21, a winding step S22, a rolling step S23 and a shaping step S24.

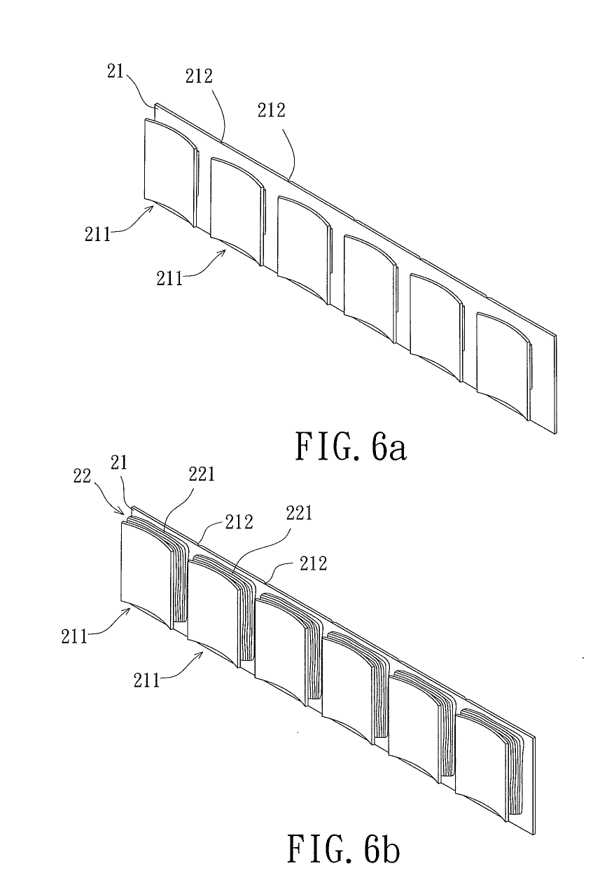

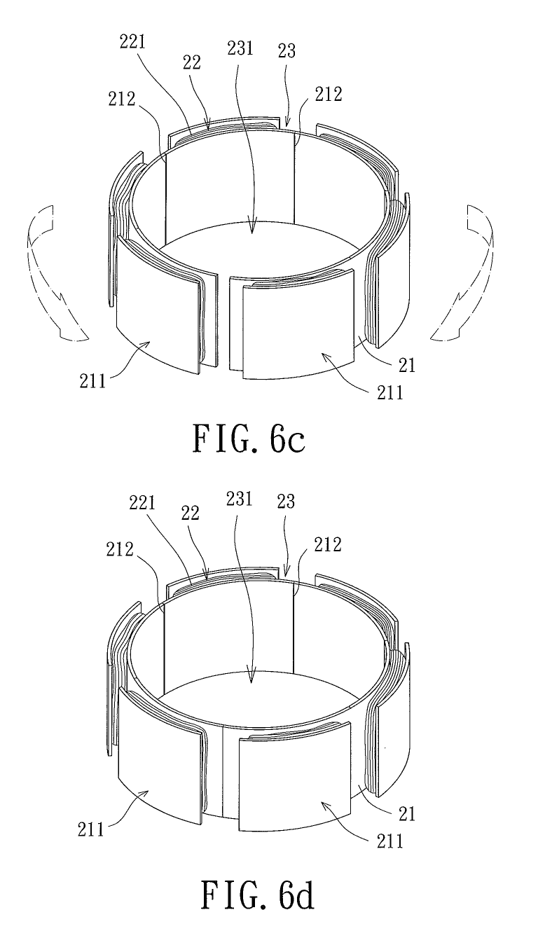

Referring to FIG. 6a, the preliminary step S21 is to provide a strip plate 21. At least one wound portion 211 is formed on a surface of the strip plate 21. The strip plate 21 may be processed to form at least one groove 212 on another surface thereof, with the at least one wound portion 211 and the at least one groove 212 located on different surfaces. The details of the preliminary step S21 is the same as the previous preliminary step S11, so it's not described herein for brevity.

Also with reference to FIG. 6b, the winding step S22 is to provide a coil unit 22 comprising a plurality of coils 221, each being wound around an individual wound portion 211. The details of the winding step S22 is the same as the previous winding step S12, so it's not described herein for brevity.

Referring to FIG. 6c, the rolling step S23 is to roll up the strip plate 21 by a machine or manpower so as to form an unshaped sleeve 23 having a central hole 231, with the wound portions 211 and the coil unit 22 located out of the central hole 231. Furthermore, the grooves 212 formed on another surface of the strip plate 21 also facilitate rolling-up of the strip plate 21.

In FIG. 6d, the shaping step S24 is to shape the unshaped sleeve 23 into a fixed cylindrical form so as to form a stator structure. More specifically, two ends of the strip plate 21 may be coupled together to shape the unshaped sleeve 23 into a shaped sleeve. The two ends of the strip plate 21 may be coupled together by ways of buckling, adhesion, soldering and so on.

Through the previous steps S21 to S24, the proposed manufacturing method of a stator of a motor according to the second embodiment of the invention also achieves advantages such as simple manufacturing and easy winding etc. Note the stator manufacturing method in the second embodiment of the invention aims at the stator manufacturing for outer-rotor-type motors, whereas the one in the first embodiment of the invention is directed to the stator manufacturing for inner-rotor-type motors.

The manufacturing methods in the first and second embodiments of the invention may be further modified to include more features. The stator manufacturing method of the first embodiment will be used as an example for illustration purpose as described below.

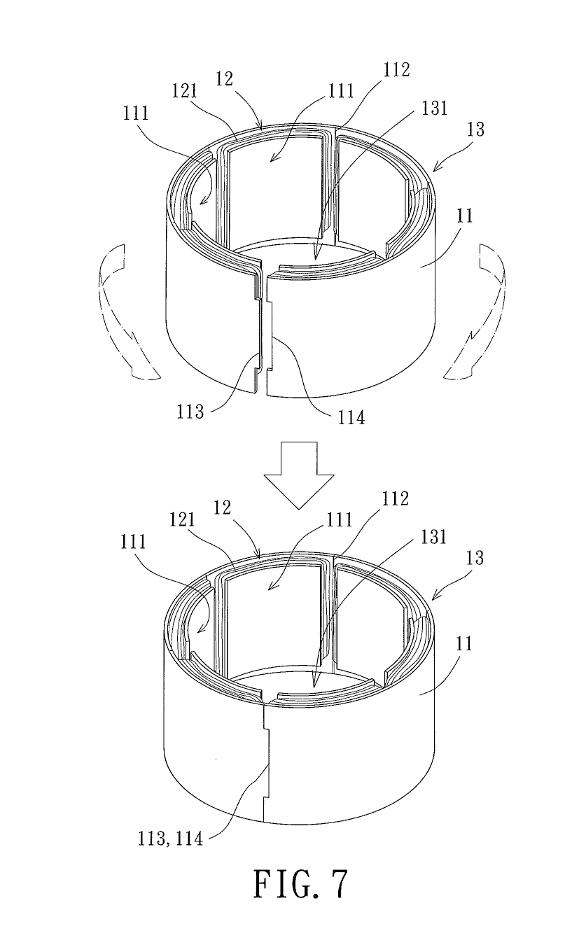

Referring to FIG. 7, as a preferable case, the strip plate 11 is further processed to form a protruding portion 113 and a receiving portion 114. The protruding portion 113 may be coupled to the receiving portion 114 during the shaping step S14. In this way, undesired axial shift of the strip plate 11 may be avoided when coupling two ends of the strip plate 11.

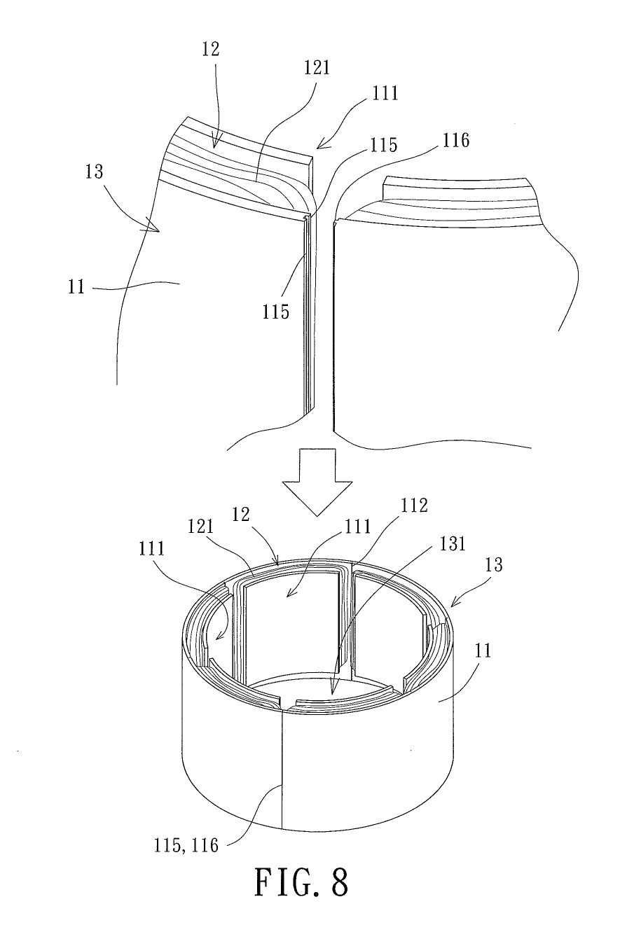

Referring to FIG. 8, as another preferable case, one end of the strip plate 11 is processed to form two connection portions 115 having a spacing therebetween. In addition, another end of the strip plate 11 is processed to form a wedging portion 116 to be wedged in the spacing of the connection portions 115 during the shaping step S14. In this way, undesired radial shift of the strip plate 11 may be avoided when coupling two ends of the strip plate 11.

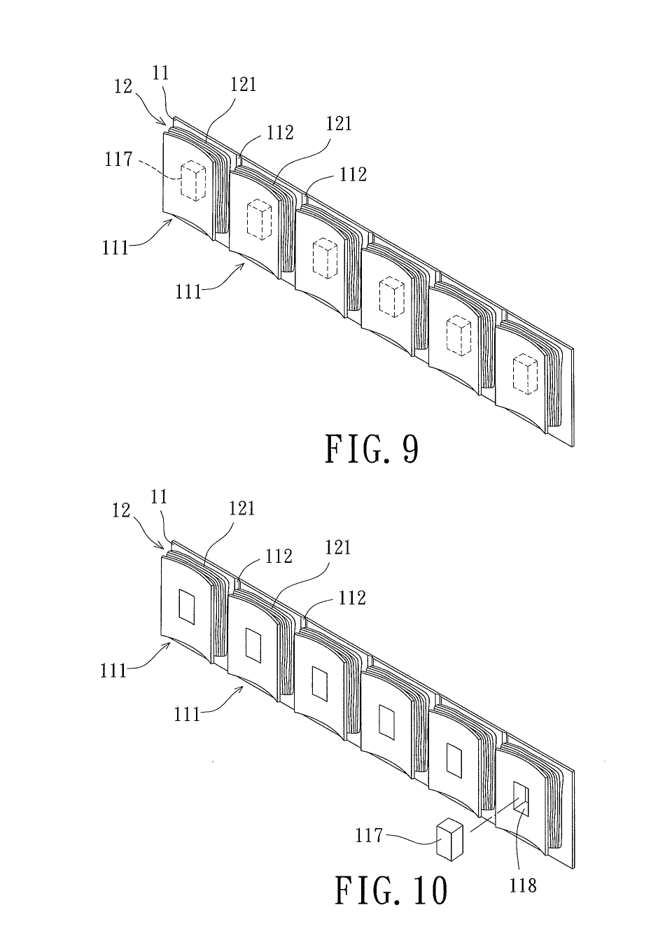

Referring to FIG. 9, the strip plate 11 is preferably formed by way of injection molding. During the injection molding, at least one magnetic conducting element 117 is preferably embedded in each wound portion 111. Based on this, when the stator is used in a motor to drive a rotor thereof, a better magnetic conducting effect may be provided.

Referring to FIG. 10, each wound portion 111 of the strip plate 11 may be processed to form at least one compartment 118 on a surface thereof for receiving the at least one magnetic conducting element 117. Based on this, when the stator is used in a motor to drive a rotor thereof, a better magnetic conducting effect is also provided.

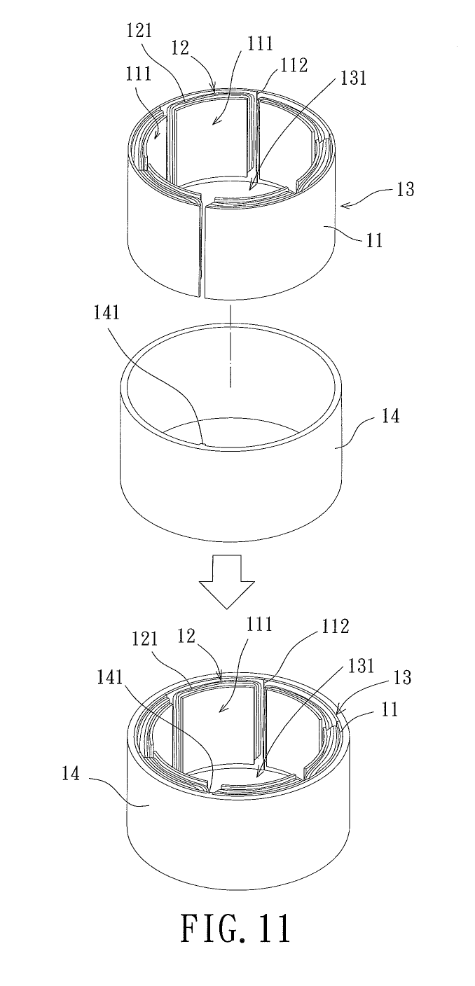

Referring to FIG. 11, the outer sleeve 14 may be processed to form a protruding pole 141 on an inner peripheral surface thereof. The protruding pole 141 is received between two ends of the strip plate 11 after the unshaped sleeve 13 (rolled-up strip plate 11) is disposed in the outer sleeve 14. In this way, undesired rolling of the unshaped sleeve 13 inside the outer sleeve 14 is prevented.

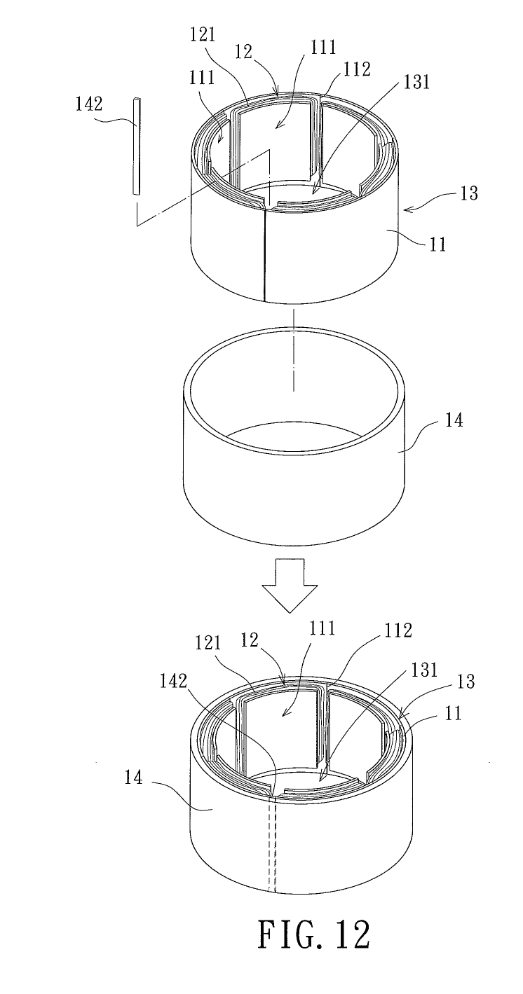

Referring to FIG. 12, a separation member 142 may be provided for the unshaped sleeve 13. As the unshaped sleeve 13 (rolled-up strip plate 11) is disposed in the outer sleeve 14, the separation member 142 may be inserted between two ends of the strip plate 11, forcing the two ends of the strip plate 11 to stay away from each other. As a result, an outer peripheral surface of the unshaped sleeve 13 may closely abut with an inner peripheral surface of the outer sleeve 14.

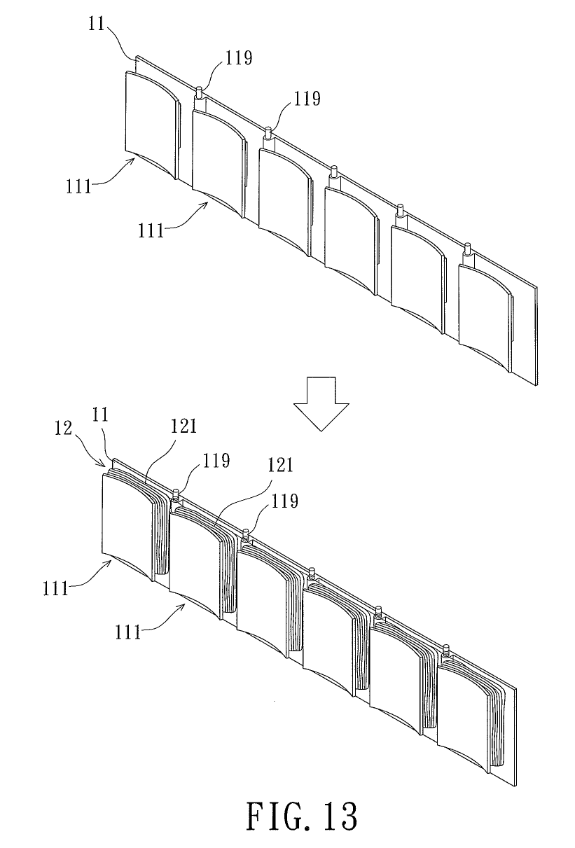

Referring to FIG. 13, as another preferable case, the strip plate 11 is processed to form at least one wire-fixing member 119 on a surface of the strip plate 11. The at least one wire-fixing member 119 may be formed on any proper location(s) of the strip plate 11. Specifically, the number of the at least one wire-fixing member 119 may be one and the single wire-fixing member 119 may be located between any two adjacent wound portions 111 (not shown). Alternatively, there may be a plurality of wire-fixing members 119 provided, each being located between two adjacent wound portions 111 (as shown in FIG. 13) or on a respective wound portion 111 (not shown). In this way, during the winding of the coil unit 12, the coil unit 12 may also wind around the at least one wire-fixing member 119 for fixing purpose so that advantages such as easy winding and better fixing of the coil unit 12 are achieved. Specifically, referring to FIG. 13, assume a stator comprising six wound portions 111 is manufactured for a triple-phased motor. In this case, the first and fourth wound portions 111 may be wound by a metal wire and the remaining metal wire may be fixed to one of the wire-fixing members 119. The wire-fixing member 119, however, may be made of a metal material or nonmetal material such as plastic. If the wire-fixing member 119 is made of a metal material which conducts electricity, the wire-fixing member 119 may be directly connected to a circuit board (not shown) of the triple-phased motor after fixing the remaining metal wire of the first and fourth wound portions 111 on the wire-fixing member 119. In another case where wire-fixing member 119 is made of a nonmetal material such as plastic, the remaining wire may be connected to the circuit board of the triple-phased motor. Similarly, the second and fifth wound portions 111 may be wound by another metal wire and the remaining metal wire may be fixed to another wire-fixing member 119.

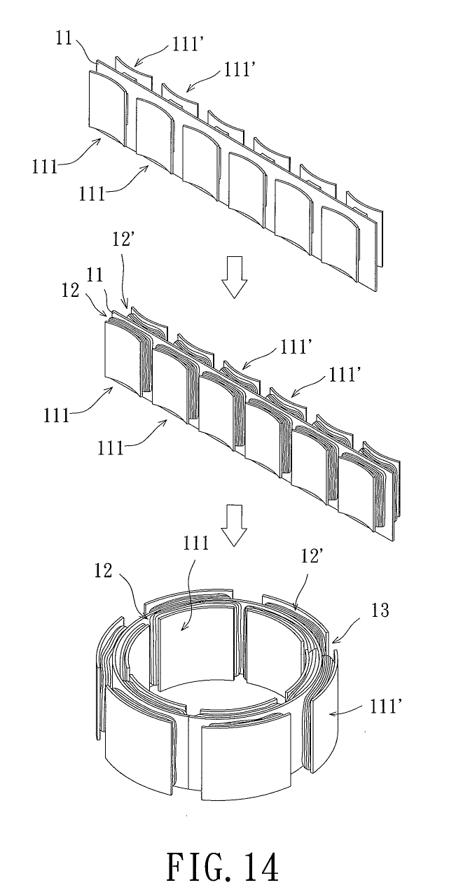

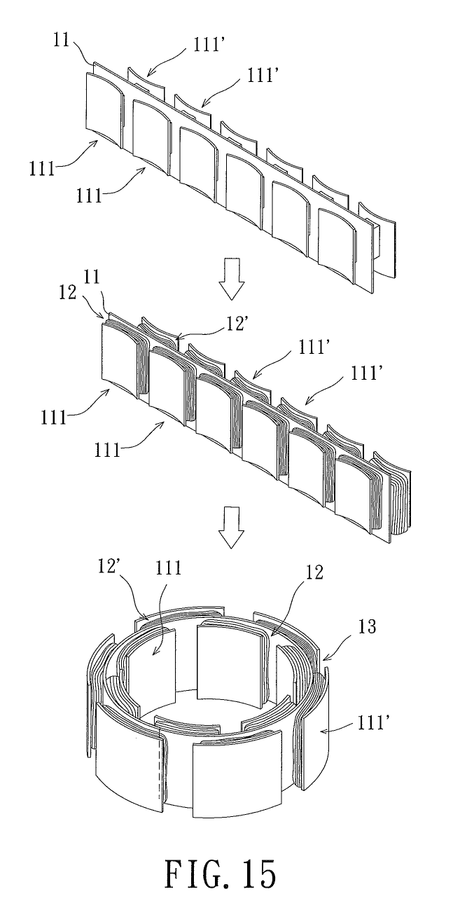

Referring to FIG. 14, the strip plate 11 not only can form at least one wound portion 111 on a surface thereof, but also at least one outer wound portion 111′ on another surface thereof. Based on this, an outer coil unit 12′ may be used to wind around the at least one outer wound portion 111′ during the winding step S12. Hence, two surfaces of the unshaped sleeve 13 are respectively wound with the coil unit 12 and the outer coil unit 12′ upon completion of the rolling step S13 and the shaping step S14. Thus, when applying to a motor, the invention may achieve advantages such as increasing the torque and rotational speed of the motor. Referring to FIG. 14 again, when the number of the wound portions 111 is equal to the number of the outer wound portions 111′, each wound portion 111 and outer wound portion 111′ may be located side by side along two surfaces of the strip plate 11. Alternatively, as shown in FIG. 15, the wound portions 111 may be located in an interlaced manner with the outer wound portions 111′ on two surfaces of the strip plate 11. Specifically, a given wound portion 111 on a surface of the strip plate 11 is located between two adjacent outer wound portions 111′ on another surface of the strip plate 11, or a given outer wound portion 111′ on a surface of the strip plate 11 is located between two adjacent wound portions 111 on another surface of the strip plate 11. The interlaced arrangement of the wound portions 111 and the outer wound portion 111′ may improve operation stability of a motor compared to the previous embodiments.

The manufactured stator in the previous embodiments may further comprise at least the following modifications.

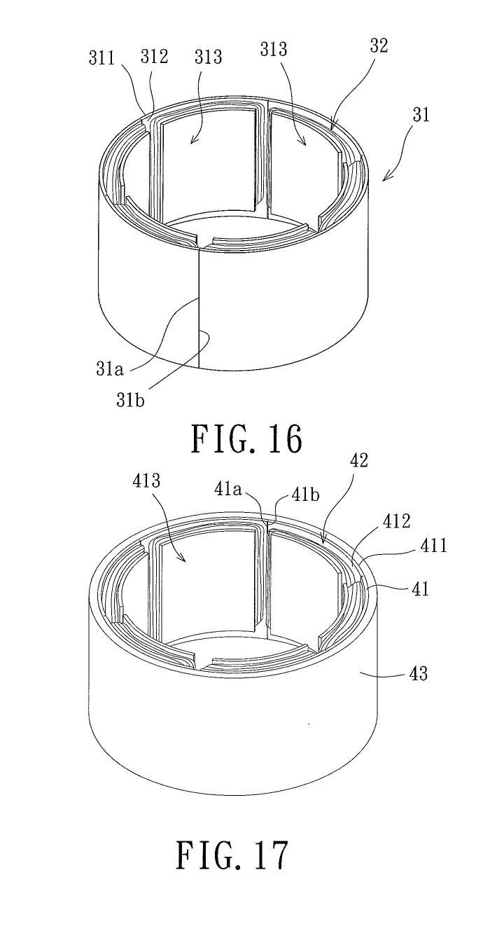

Referring to FIG. 16, the first embodiment of the invention comprises an unshaped sleeve 31 and a coil unit 32. The unshaped sleeve 31 is a rolled-up strip plate having a first coupling end 31a and a second coupling end 31b on two ends thereof. The unshaped sleeve 31 has a coupling portion where the first coupling end 31a and the second coupling end 31b are coupled with each other. The unshaped sleeve 31 also has an outer peripheral surface 311 and an inner peripheral surface 312, with the inner peripheral surface 312 having a plurality of wound portions 313 extended therefrom. The wound portions 313 are wound with the coil unit 32 and may be evenly or unevenly spaced on the inner peripheral surface 312.

Referring to FIG. 17, a stator of a motor comprises an unshaped sleeve 41, a coil unit 42 and an outer sleeve 43 according to the second embodiment of the invention. The unshaped sleeve 41 is a rolled-up strip plate and has an outer peripheral surface 411 and an inner peripheral surface 412. The inner peripheral surface 412 has a plurality of wound portions 413 extended therefrom. The wound portions 413 are wound with the coil unit 42 and may be evenly or unevenly spaced on the inner peripheral surface 412. The outer sleeve 43 is coupled with the outer peripheral surface 411 of the unshaped sleeve 41. The strip plate forming the unshaped sleeve 41 may have a first coupling end 41a and a second coupling end 41b on two ends thereof. To have better shaping effect for the unshaped sleeve 41, the unshaped sleeve 41 preferably has a coupling portion where the first coupling end 41a and the second coupling end 41b are coupled with each other.

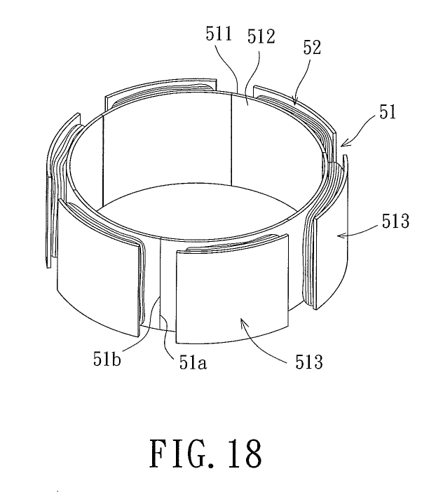

Referring to FIG. 18, a stator of a motor comprises an unshaped sleeve 51 and a coil unit 52 according to the third embodiment of the invention. The unshaped sleeve 51 is a rolled-up strip plate having a first coupling end 51a and a second coupling end 51b on two ends thereof. The unshaped sleeve 51 has a coupling portion where the first coupling end 51a and the second coupling end 51b are coupled with each other. The unshaped sleeve 51 has an outer peripheral surface 511 and an inner peripheral surface 512, with the outer peripheral surface 511 having a plurality of wound portions 513 extended therefrom. The wound portions 513 are wound with the coil unit 52 and may be evenly or unevenly spaced on the outer peripheral surface 511.

In the various embodiments previously disclosed, the first coupling ends 31a, 41a and 51a may be respectively coupled with the second coupling ends 31b, 41b and 51b by way of buckling as described in FIGS. 7 and 8. In addition, the wound portions 313, 413 and 513 are preferably embedded with the magnetic conducting elements 117 shown in FIGS. 9 and 10. The outer sleeve 43 in the second embodiment preferably includes the structure of the outer sleeve 14 shown in FIG. 11 to prevent undesired rolling of the unshaped sleeve 41. The outer sleeve 43 in the second embodiment preferably includes the separation member 142 shown in FIG. 12. The sleeves 31, 41 and 51 in the previous embodiments may preferably include at least one wire-fixing member 119 shown in FIG. 13. The unshaped sleeve 31 in the first embodiment may preferably include the at least one outer wound portion 111′ and the outer coil unit 12′ on the outer peripheral surface 311 thereof as shown in FIGS. 14 and 15. The stators in the various embodiments described above may include substantially the same secondary features shown in FIGS. 7 to 15, so they are not described herein again for brevity.

In the various embodiments above, the unshaped sleeves 31, 41 and 51 are in form of a rolled-up strip plate and include a plurality of wound portions 313, 413 and 513 respectively wound with the coil units 32, 42 and 52. Based on the structures, the invention is capable of achieving the following advantages:

1. Low cost and easy assembly. In comparison with a conventional stator, the invention has achieved easy manufacturing and assembly of a manufactured stator as the unshaped sleeves 31, 41 and 51 are in a form of rolled-up strip plate. In addition, the invention may omit the silicon steel plates used in conventional stators, thus simplifying structure complexity, reducing costs and improving assembly convenience of the conventional stators.

2. Reduction of axial height. Since the invention may omit components such as silicon steel plates, upper and lower bobbins, the axial height of a manufactured stator is therefore reduced, allowing the implementation of a miniaturized stator.

3. Stable operation. When the invention is applied to a motor, the cogging torque of the motor may be improved due to the absence of the silicon steel plates. In this way, the rotor vibration of the motor is prevented.

As described previously, the stator of the invention does have advantages such as easy manufacturing and winding. Especially, when the proposed stator manufacturing method is applied to inner-rotor-type motors, the torque and rotational speed of the inner-rotor-type motors are significantly improved. In the other aspect, the invention also achieves advantages such as low cost, easy assembly, reduced axial height, stable operation and so on.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A stator manufacturing method for a motor, comprising:
a preliminary step configured to provide a strip plate having at least one wound portion on a surface thereof;
a winding step configured to provide a coil unit and wind the coil unit around the at least one wound portion of the strip plate;
a rolling step configured to roll up the strip plate into an unshaped sleeve having a central hole, wherein the at least one wound portion and the coil unit are located inside the central hole; and
a shaping step configured to fix a shape of the unshaped sleeve so as to form a shaped sleeve.

2. The stator manufacturing method for the motor as claimed in claim 1, wherein the shaping step is configured to couple two ends of the strip plate so as to fix the shape of the unshaped sleeve.

3. The stator manufacturing method for the motor as claimed in claim 2, wherein the two ends of the strip plate are coupled by ways of buckling, adhesion or soldering.

4. The stator manufacturing method for the motor as claimed in claim 3, wherein the two ends of the strip plate are formed as a protruding portion and a receiving portion, respectively.

5. The stator manufacturing method for the motor as claimed in claim 3, wherein one of the two ends of the strip plate is formed as two connection portions and the other one of the two ends of the strip plate is formed as a wedging portion.

6. The stator manufacturing method for the motor as claimed in claim 1, wherein the shaping step is further configured to provide an outer sleeve, and the unshaped sleeve is disposed in the outer sleeve.

7. The stator manufacturing method for the motor as claimed in claim 6, wherein a separation member is inserted between two ends of the strip plate after the unshaped sleeve is disposed in the outer sleeve, thereby forcing the unshaped sleeve to closely abut with an inner peripheral surface of the outer sleeve.

8. The stator manufacturing method for the motor as claimed in claim 6, wherein the outer sleeve is made of a material capable of preventing magnetic field leakage.

9. The stator manufacturing method for the motor as claimed in claim 1, wherein the strip plate is formed by way of injection molding, and at least one magnetic conducting element is embedded in the at least one wound portion during the injection molding.

10. The stator manufacturing method for the motor as claimed in claim 1, wherein each of the at least one wound portion forms a compartment on a surface thereof, and a magnetic conducting element is embedded in the compartment.

11. The stator manufacturing method for the motor as claimed in claim 1, wherein the strip plate is made of an insulation material.

12. The stator manufacturing method for the motor as claimed in claim 1, wherein the strip plate forms at least one wire-fixing member on the surface thereof, and remaining wire of the coil unit is fixed to the at least one wire-fixing member during the winding step.

13. The stator manufacturing method for the motor as claimed in claim 1, wherein the outer sleeve forms a protruding pole on an inner peripheral surface thereof, and the protruding pole is received between two ends of the strip plate when the unshaped sleeve is disposed in the outer sleeve.

14. The stator manufacturing method for the motor as claimed in claim 1, wherein the strip plate forms at least one groove on the surface thereof for the strip plate to be rolled-up into the unshaped sleeve.

15. The stator manufacturing method for the motor as claimed in claim 1, wherein the strip plate forms at least one outer wound portion on another surface thereof, and an outer coil unit is wound around the at least one outer wound portion during the winding step.

16. A stator manufacturing method for a motor, comprising:
a preliminary step configured to provide a strip plate having at least one wound portion on a surface thereof;
a winding step configured to provide a coil unit and wind the coil unit around the at least one wound portion of the strip plate;
a rolling step configured to roll up the strip plate into an unshaped sleeve having a central hole, wherein the at least one wound portion and the coil unit are located outside the central hole; and
a shaping step configured to couple two ends of the strip plate so as to shape the unshaped sleeve into a shaped sleeve.

17. The stator manufacturing method for the motor as claimed in claim 16, wherein the two ends of the strip plate are coupled by ways of buckling, adhesion or soldering.

18. The stator manufacturing method for the motor as claimed in claim 17, wherein the two ends of the strip plate are formed as a protruding portion and a receiving portion, respectively.

19. The stator manufacturing method for the motor as claimed in claim 17, wherein one of the two ends of the strip plate is formed as two connection portions and the other one of the two ends of the strip plate is formed as a wedging portion.

20. The stator manufacturing method for the motor as claimed in claim 16, wherein the strip plate is formed by way of injection molding, and at least one magnetic conducting element is embedded in the at least one wound portion during the injection molding.

21. The stator manufacturing method for the motor as claimed in claim 16, wherein each of the at least one wound portion forms a compartment on a surface thereof, and a magnetic conducting element is embedded in the compartment.

22. The stator manufacturing method for the motor as claimed in claim 16, wherein the strip plate is made of an insulation material.

23. The stator manufacturing method for the motor as claimed in claim 16, wherein the strip plate forms at least one wire-fixing member on the surface thereof, and remaining wire of the coil unit is fixed to the at least one wire-fixing member during the winding step.

24. The stator manufacturing method for the motor as claimed in claim 16, wherein the strip plate forms at least one groove on the surface thereof for the strip plate to be rolled-up into the unshaped sleeve.

25. A stator of a motor, comprising an unshaped sleeve in form of a rolled-up strip plate and having a plurality of wound portions wound with a coil unit.

26. The stator of the motor as claimed in claim 25, wherein the rolled-up strip plate has a first coupling end and a second coupling end on two ends thereof, the unshaped sleeve has an outer peripheral surface, an inner peripheral surface, and a coupling portion where the first coupling end and the second coupling end are coupled with each other, and the wound portions are formed on the inner peripheral surface.

27. The stator of the motor as claimed in claim 26, wherein the outer peripheral surface forms a plurality of outer wound portions wound with an outer coil unit.

28. The stator of the motor as claimed in claim 27, wherein each of the wound portions is located side-by-side with a respective one of the outer wound portions.

29. The stator of the motor as claimed in claim 27, wherein the wound portions are located in an interlaced manner with the outer wound portions.

30. The stator of the motor as claimed in claim 25, wherein the rolled-up strip plate has a first coupling end and a second coupling end on two ends thereof, the unshaped sleeve has an outer peripheral surface, an inner peripheral surface, and a coupling portion where the first coupling end and the second coupling end are coupled with each other, and the wound portions are formed on the outer peripheral surface.

31. The stator of the motor as claimed in claim 25, wherein the unshaped sleeve is disposed in an outer sleeve and has an inner peripheral surface and an outer peripheral surface, and the wound portions are formed on the inner peripheral surface.

32. The stator of the motor as claimed in claim 31, wherein the rolled-up strip plate has a first coupling end and a second coupling end on two ends thereof, and the unshaped sleeve has a coupling portion where the first coupling end and the second coupling end are coupled with each other.

33. The stator of the motor as claimed in claim 31, wherein the outer sleeve forms a protruding pole on an inner peripheral surface thereof, and the protruding pole is received between two ends of the rolled-up strip plate when the unshaped sleeve is disposed in the outer sleeve.

34. The stator of the motor as claimed in claim 31, wherein a separation member is coupled to an inner peripheral surface of the outer sleeve, and the separation member is inserted between two ends of the rolled-up strip plate after the unshaped sleeve is disposed in the outer sleeve.

35. The stator of the motor as claimed in claim 25, wherein the unshaped sleeve is made of an insulation material.

36. The stator of the motor as claimed in claim 25, wherein at least one magnetic conducting element is coupled to the wound portions.

37. The stator of the motor as claimed in claim 25, wherein the unshaped sleeve has at least one wire-fixing member fixing remaining wire of the coil unit.

38. The stator of the motor as claimed in claim 26, wherein the first coupling end forms a protruding portion and the second coupling end forms a receiving portion, and protruding portion is received in the receiving portion.

39. The stator of the motor as claimed in claim 26, wherein the first coupling end forms two connection portions and the second coupling end forms a wedging portion wedged between the two connection portions.
